(19) United States
(12) Patent Application Publication
(10) Pub. No.: US 2013/0306738 A1
(43) Pub. Date: Nov. 21, 2013

(54) EVENT BADGE AND HOLDER THEREFOR

(71) Applicants: Robert W. Peterson, Mount Prospect, IL (US); James H. Fackert, Brighton, MI (US); Russell R. Armentrout, Roselle, IL (US); Tommy Edwards, Wooddale, IL (US); Robert J. Mondo, JR., Roselle, IL (US)

(72) Inventors: Robert W. Peterson, Mount Prospect, IL (US); James H. Fackert, Brighton, MI (US); Russell R. Armentrout, Roselle, IL (US); Tommy Edwards, Wooddale, IL (US); Robert J. Mondo, JR., Roselle, IL (US)

(21) Appl. No.: 13/474,410

(22) Filed: May 17, 2012

(51) Int. Cl. A44C 3/00; H05B 37/02; G06K 19/073

(52) U.S. Cl. 235/492; 40/1.5; 235/494

(57) ABSTRACT

A badge holder comprises an illumination device, a badge, a memory, and a controller. The controller receives environmental conditions sensed by a sensor and, in response, actuates the illumination device.

### BACKGROUND OF THE INVENTION

1. Field of the Invention

The present invention is directed to an event badge and a holder therefor and, in particular, an event badge and/or holder that is responsive to the environment in which it is used.

2. Background of the Invention

When attending a convention, seminar, trade show, sporting or entertainment event, and the like, an attendee typically receives or otherwise acquires a badge. Often the attendee may wear the badge using a lanyard secured thereto. To prevent fraud, the badge includes one or more indicia such as a hologram and/or a barcode to confirm the authenticity of the badge and/or to prevent fraudulent duplication thereof. The badge may be also be encoded to allow the holder thereof entrance to particular portions of an event, such as, specific talks or meetings of a conference or backstage at a performance. Further, some badges may be printed thereon with marketing information about the event, performers at the event, sponsors of the event, and the like.

After the using the badge to gain entry into an event, the attendee may stow or wear the badge.

After the event the attendee may simply discard the badge. Some attendees consider the badge “collectible,” as a souvenir of the event, and may add such badge to a collection of badges. However, even if an attendee saves the badge, the attendee may only sporadically view or display the badge as a part of the collection.

### SUMMARY OF THE INVENTION

According to one aspect of the invention, a badge holder that includes a battery, a switch, and an illumination device and a badge disposed in the badge holder. The badge may include a security identifier, wherein the security identifier allows validation of the authenticity of the badge. The badge holder may include a controller that receives environmental conditions sensed by a sensor and, in response, actuates the illumination device. Actuation of the illumination device causes illumination of a surface of the badge.

Optionally, the environmental conditions sensed by the sensor include a change in audio or illumination in the environment.

Optionally, the controller operates the illumination device in synchrony with changes in the audio or illumination in the environment.

Optionally, the security identifier may be a barcode, serial number integrated circuit, memory having a security code stored therein, and/or two-dimensional barcode.

Optionally, the data stored in the badge may be transmitted to a server and content may be received from the server in response to such transmission by any communications means.

Optionally, the badge holder is connected to a computer using a wireless or a USB connection to facilitate communication with the computer or a server remote from the computer or to facilitate charging a power source in the badge holder.

### BRIEF DESCRIPTION OF THE DRAWINGS

FIG. 1 is an isometric view of an embodiment of a badge holder and a badge in accordance with the present invention;

FIG. 2A is an isometric view of the badge holder of FIG. 1;

FIG. 2B is an isometric view of the badge holder of FIG. 1;

FIG. 3 is a block diagram of the components of a control unit of the badge holder of FIG. 1;

FIG. 4 is an isometric view of the bade of FIG. 1;

FIGS. 5A and 5B are elevational views of an inner surface of the badge holder of FIG. 1;

FIG. 6 is a block diagram of a system that validates the authenticity of the badge of FIG. 1;

FIG. 7 is a flowchart of processing undertaken by a server to validate the authenticity of the badge of FIG. 1;

FIGS. 8 and 9 are a flowchart of processing undertaken by a control unit of the badge holder of FIG. 1;

FIG. 10 is a block diagram of how the badge holder of FIG. 1 may communicate with a server;

FIG. 11 is an isometric view of another badge in accordance with the present invention;

FIG. 12 is a side planar view of a badge holder in accordance with the present invention with the badge of FIG. 11 disposed therein;

FIG. 13 is planar view of an interior of the badge holder of FIG. 12;

FIG. 14 is an isometric view of another badge holder;

FIG. 15A is an isometric view of the badge holder 14 with the badge of FIG. 11 disposed therein;

FIG. 15B is a sectional view taken along the line A-A of the badge holder and badge of FIG. 15A; and

FIG. 16 is an isometric view of another embodiment of a badge.

### DETAILED DESCRIPTION OF THE PREFERRED EMBODIMENTS

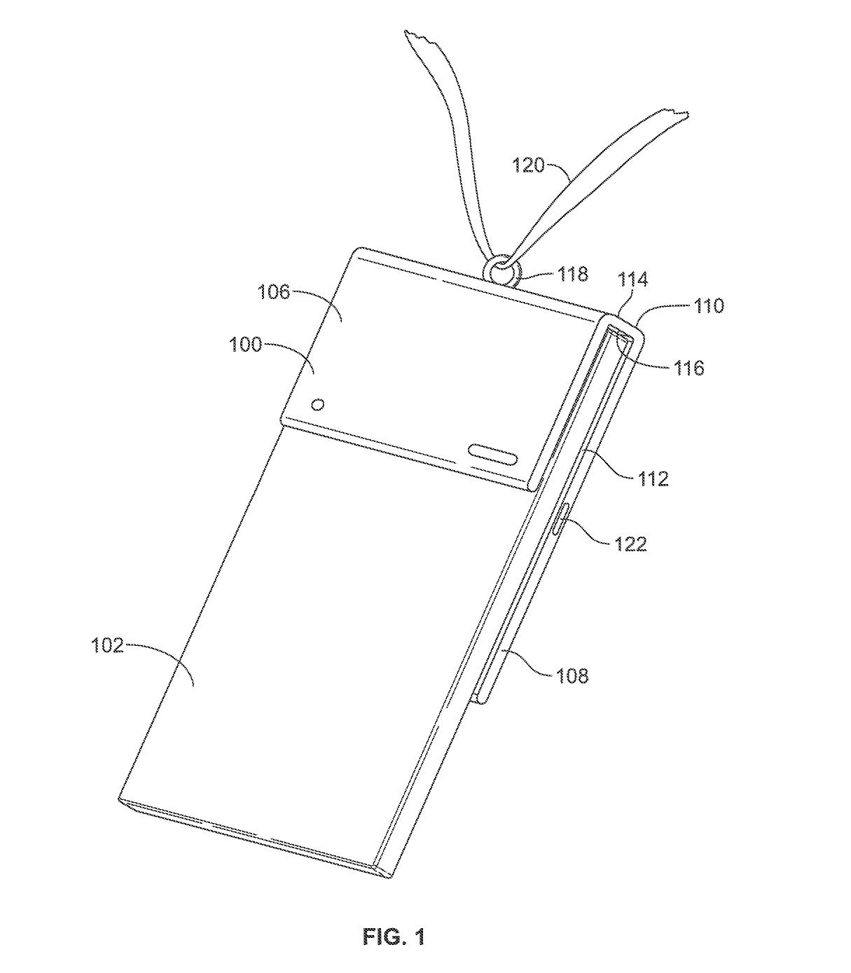

Referring to FIG. 1 a badge holder 100 for a badge 102 includes a front portion 106 and a rear portion 108 coupled to one another by a top portion 110. In some embodiments the front portion 106, the rear portion 108, and the top portion 110 may be contiguous and formed by a planar plate bent into a c-shape. In other embodiments, the front, rear, and/or top portions 106, 108, and 110, respectively, may be formed from separate pieces that are joined or used to one another. The front, rear, and top portions, 106, 108, and 110, respectively, create a space 112 between the front portion 106 and the rear portion 108 into which the badge 102 may be inserted.

The top portion 110 includes an outer surface 114 and an inner surface 116. A loop 118 is secured to the outer surface 114 of the top portion 110. A lanyard 120 may be secured to the loop 118 to permit a user to wear thereon the badge holder 100 and the badge 102 inserted in the space 112. The badge holder 100 may also include a communication port, such as a USB port 122, that allows the badge holder 100 to communicate with other devices, for example, a personal computer.

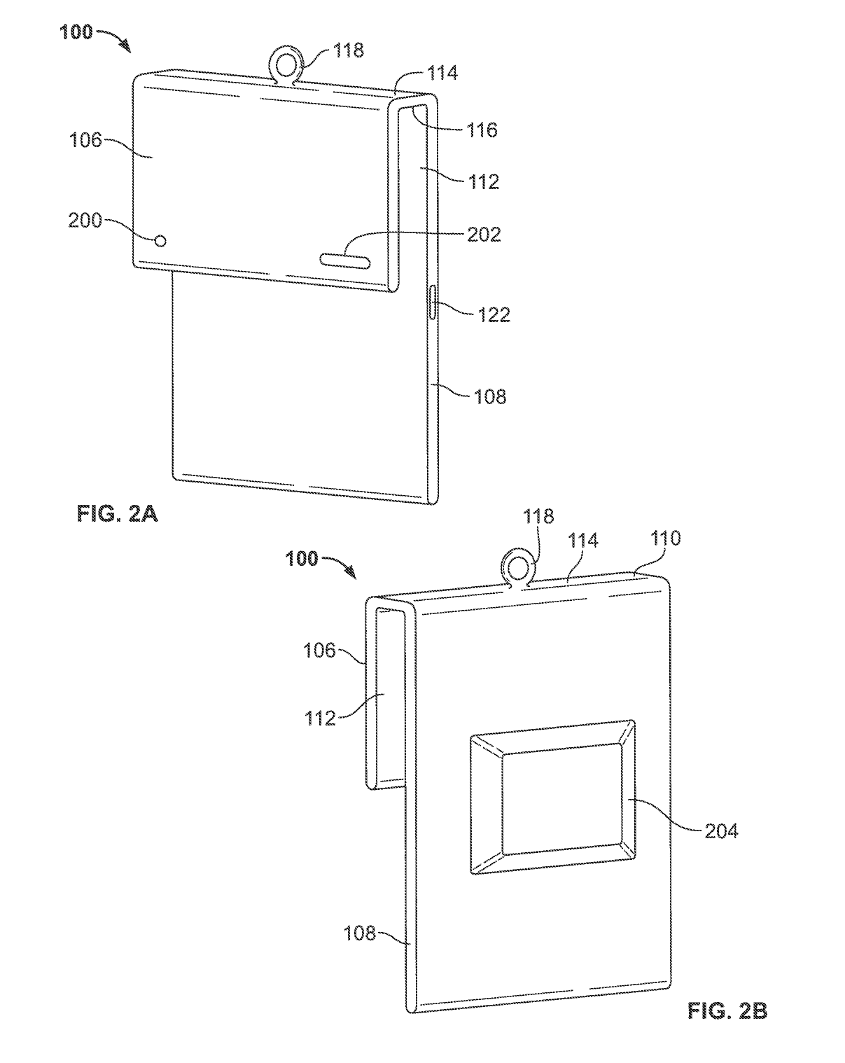

Referring also to FIG. 2, a mode selection button 200 and one or more sensor(s) 202 are disposed on the front portion 106 of the badge holder 100. In some embodiments, the mode selection button 200 and/or the sensor(s) 202 may be disposed on the top portion 110 or the rear portion 108. It should be apparent that the mode selection button 200 and the sensor(s) 202 may be disposed on different portions 106, 108, and 110 of the badge holder 100. In some embodiments the mode selection button 200 may be used to turn on or turn off the badge holder 100 in addition to selecting an operating mode as described below. In addition, if the badge holder 100 includes a plurality of sensors 202, such sensors 202 may be disposed on different portions 106, 108, and 110 of the badge holder 100. The sensor(s) 202 may include any type of sensor that can sense energy in the environment where the badge holder 100 is disposed and may include one or more of an electromagnetic sensor, for example, a light sensor, an acoustic sensor, such as a sound sensor, a proximity sensor, an accelerometer, a vibration sensor, a motion sensor, a radio receiver (perhaps combined with a radio transmitter), a GPS receiver, and the like.

FIG. 2B is a rear, left side isometric view of the badge holder 100 and shows a control unit 204 disposed on the rear portion 108 of badge holder 100.

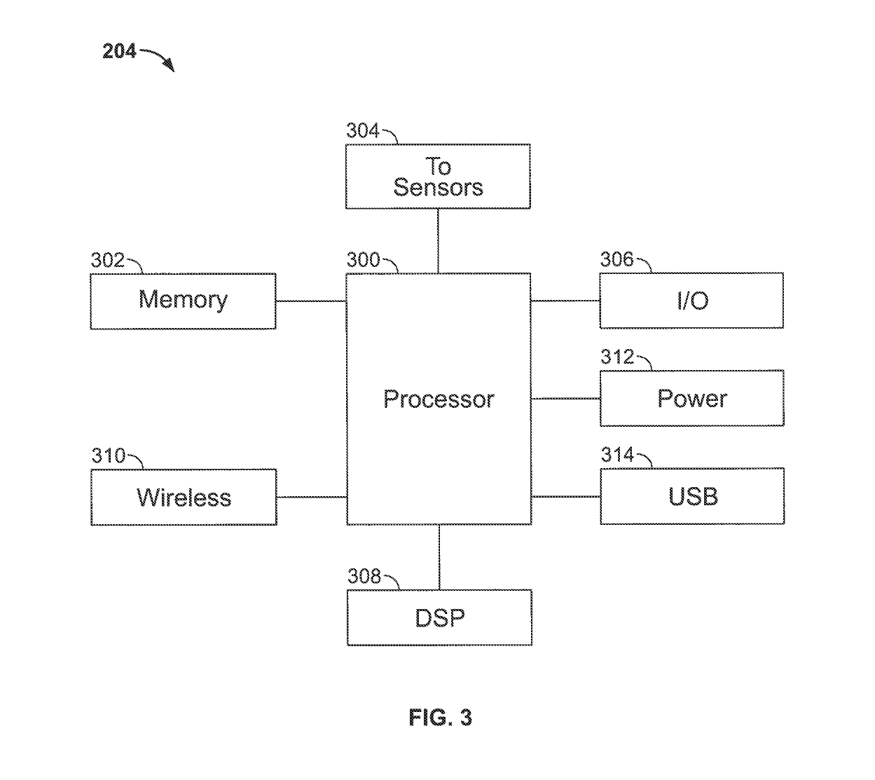

FIG. 3 is a block diagram that shows the components of the control unit 204. The control unit 204 includes a processor 300, memory 302 such as a non-volatile RAM module, input leads 304 from the sensor(s) 202, and an input/output module 306 for receiving and transmitting information to the badge 102 disposed in the badge holder 100.

The control unit 204 may optionally include one or more of a digital signal processor (DSP) 308, a wireless communication module 310, and a USB control module 314. The wireless communication module 310 may enable the control unit 204 to join an 802.11-based local area network (LAN) to communicate with other devices operating therein. In addition or alternately, the wireless communication module 310 may allow the control unit 204 to communicate with other devices in the vicinity of badge holder 102 using Bluetooth or other radio frequency based communication protocols (such as WAN, 3G, 4G or other radio/cellular communications networks). In some embodiments, the loop 118 and/or the lanyard 120 provide an antenna for the wireless communication module 310. In other embodiments, the wireless communication module 310 uses a separate antenna (not shown).

It should be apparent that the control unit 204 may be an integrated circuit that includes the functionality of the components 300-314. Alternately, the integrated circuit may include the functionality of some of the components 300-314 and additional components may be coupled to the integrated circuit to provide those functions not provided by the integrated circuit. It should be apparent the processor 300 may be any of commonly available processors. In addition, the processor 300 may be a general-purpose processor or a custom designed processor. Further, the components of the control unit 204 may be supplied by separate components, combined into a single integrated circuit such as an ASIC or and FPGA, or a combination thereof.

The components 300-310 and 314 of the control unit 204 are powered by a power source 312. In some embodiments, the power source 312 is a replaceable and/or rechargeable battery. If a rechargeable battery is used, a charger or other power source may be coupled to the communication port 122 to recharge the battery. The badge holder 100 may include a solar cell to charge the battery and/or to provide power directly to the components 300-314 of the control unit 204.

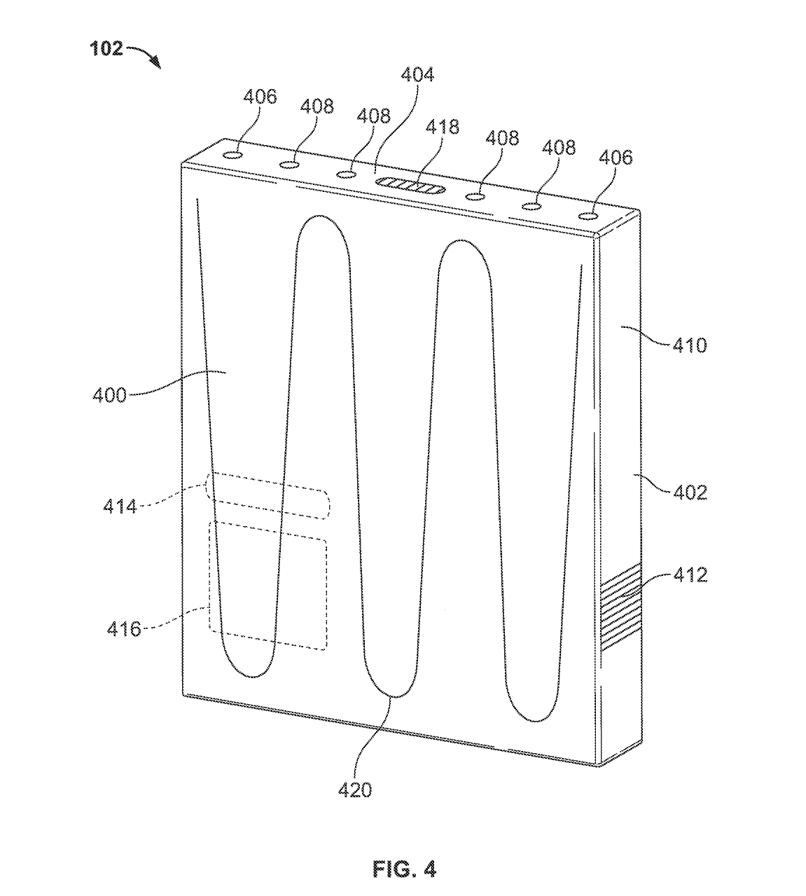

FIG. 4 shows a front, top, left side isometric view of a badge 102. In one embodiment the badge 102 is manufactured from an acrylic, a plastic, a coated board, or other durable material. The badge 102 includes a front surface 400, a rear surface 402, and a top surface 404. Disposed on the top surface 404 are one or more light-emitting diodes (LEDs) 406 and one or more magnets 408. Disposed on a side 410 are one or more unique indicia 412 etched therein or printed or applied thereon. The LEDs 406 may be mono-color, white, or composite LEDs that produce various combinations of white and colored light. It should be apparent that another illumination source may be used instead of the LED 406 including an organic LED, a CCL lamp, an incandescent lamp, a photoluminescent nanofiber, electron-stimulated luminescents, and the like.

In one embodiment, the one or more unique indicia 412 may be visible or sensed under particular circumstances. For example, the one or more unique indicia 412 may incorporate or be covered with lenticular prisms and the like so that light reflected from the one or more unique indicia 412 is viewable only from certain viewing angles. In other cases, the one or more unique indicia 412 may be printed with inks that are only visible when exposed to ultraviolet or infrared light. In still other cases, the one or more unique indicia 412 may be printed using magnetic ink so that only a reader that can detect magnetic flux may detect the one or more unique indicia 412. Typically, the one or more unique indicia 412 incorporate at least one unique identifier associated with the badge 102. In some embodiments, the identifier encoded by the one or more unique indicia 412 is determined and associated with the badge 102 when such badge 102 is manufactured. In other embodiments, the one or more unique indicia 412 are associated with the badge 102 when the badge 102 is sold, issued, or registered.

The badge 102 may include a secure memory 414. Such secure memory 414 may be non-volatile random-access memory that may that may be write-protected once written to or memory to which encrypted data is written. In some embodiments, such secure memory 414 may be a write-once-read-many memory. The secure memory 414 stores additional information that is unique to the badge 102. A unique value may be developed, encrypted, and written into the secure memory 414 when the badge 102 is manufactured. Alternately, the unique value may be developed, encrypted, and written into the secure memory 414 when the badge 102 is issued or sold to an attendee. In this case, the value written into the secure memory 414 may include at least a portion of the value encoded by the one or more unique indicia 412 that identifies the badge 102 and information that uniquely identifies the purchaser of the badge 102. The information that identifies the purchaser may include a unique registration number or user id associated with the purchaser, a driver's license number, a credit card number, and the like. Such information may also include a seat and/or section number assigned to the purchaser.

The badge 102 may also include an RPM circuit or a serial number integrated circuit 416 that is encoded so that, when excited, such circuit 416 emits a unique identifier associated with the badge 102 and/or the purchaser of the badge 102.

The one or more unique indicia 412, secure memory 414, and the RFID circuit 416 provide security measures to enable validation of the authenticity of a badge 102 and thereby thwart counterfeiting thereof. Further, the purchaser information encoded in the badge 102 may assist in identifying the rightful owner of a badge 102 that is recovered after being reported stolen or lost.

The one or more unique indicia 412, secure memory 414, and/or the RFID circuit 416 may also have data encoded therein that identifies a location (e.g., an assigned seat) and/or a valid date associated with the badge.

One embodiment of the badge 102 is manufactured of a transparent material such as a transparent acrylic or plastic. The rear surface 402 of such badge 1.02 comprises a reflective coating applied thereto. In some embodiments such coating is a diffused reflective coating. In other embodiments, such coating is a specular reflective coating. In one embodiment, the rear surface 402 has a metallic coating such as aluminum or is metalized. In some embodiments, the front surface 400 and/or another portion of the badge 102 includes light guides 420 for directing light from the LEDs 406 to illuminate the front surface 400 of the badge 102. The light guides 420 may also direct light emitted by the LEDs 406 toward the coating applied to the rear surface 402 of the badge 102 so that such light may be reflected by such coating and project outwardly from the front surface 400 of the badge.

In some embodiments, the front surface 400 of the badge 102 may be printed with an image. In some embodiments, semi-transparent inks or coatings may be used to imprint the front surface and still allow light directed by the light guides to project outwardly from the front surface 400 of the badge 102. In other embodiments, the printing may not completely occlude the front surface 400 of the badge 102 and the light may be projected through portions of the front surface 400 not occluded by such printing.

In some embodiments, a reflective or diffuse image may be printed on the rear surface 402 of the badge 102 such that light from the LEDs 406 may reflect off or be diffused by such image and directed outwardly from the front surface 400 of the badge 102. The badge 102 may have light diffusive particles incorporated therein that scatter light from the LEDs 406 so that such light is projected outwardly from the front surface 400 of the badge 102. It should be apparent, that the badge 102 may include any combination of light guides, an image printed on the front surface 400, an image printed on the rear surface 402, and light diffuse particles incorporated into the badge 102. The badge may also incorporate other ways of diffusing or reflecting light or illuminating the badge 102 apparent to those of skill in the art.

Some embodiments of the badge 102 may have a Quick Response (QR) or other barcode printed on any surface thereof A user may scan the QR barcode before, during, or after the event associated with the badge 102 with an appropriate device. Scanning the QR barcode may direct a web browser operating on the scanning device to a web site associated with the event. Other types of encoding may be printed on the badge 102 to allow a user to obtain additional information regarding the event associated with the badge 102. The QR barcode may encode information that identifies the badge 102, event, and/or user associated with the badge 102.

It should be apparent that the purchaser of the badge 102 and an attendee who uses the badge 102 might be different. In such cases, the secure memory 414 and/or the RFD circuit 416 may be encoded with information that identifies one or both of the purchaser and the attendee.

Disposed on the top surface 404 of the badge 102 are electrical contacts 418 that are electrically connected to the LEDs 406, the secure memory 414, and the MD circuit 416. It should be apparent that such electrical contacts 418 may be disposed on any surface of the badge 102.

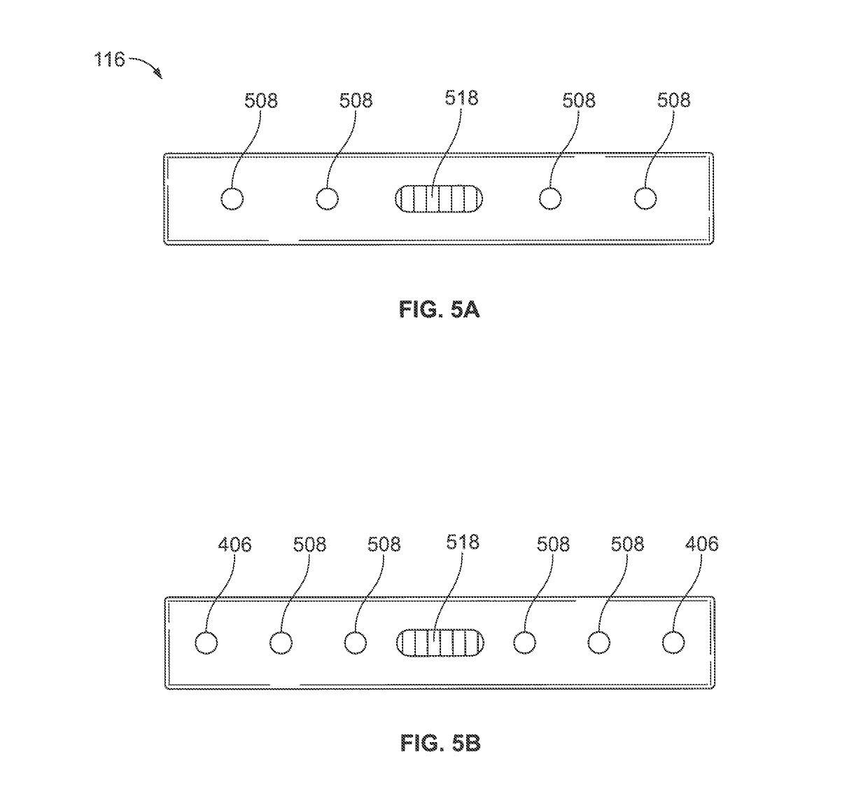

FIG. 5A is an elevational view of the inner surface 116 of the top portion 110 of the badge holder 100. The inner surface 116 has disposed thereon one or more magnets 508 and electrical contacts 518. The electrical contacts 518 are electrically connected to input and output leads of the input/output module 306 of the control unit 204.

In some embodiments, the badge holder 100 includes the LEDs 406. FIG. 5B is an elevational view of the inner surface 116 of such an embodiment of the badge holder 100. It should be apparent, that the badge 102 used with such a badge holder 100 need not have any LEDs 406 disposed thereon.

In one embodiment, there is a one-to-one correspondence between each magnet 508 disposed on the inner surface 116 and a magnet 408 disposed on the top surface 404 of the badge 102. In addition, the spacing between the magnets 508 is substantially identical to the spacing between the magnets 408 and each magnet 508 has a polarity opposite to that of the magnet 408 corresponding thereto. However, the polarities of each of the magnets 408 do not have to be identical to one another and similarly the polarities of the magnets 508 do not have to be identical to one another. In one embodiment, the magnets 408 and 508 are manufactured from neodymium or another material having strong magnetic properties so that the badge 102 is securely, but releasably, held in the badge holder 100. However, other magnetic material may be used and, in some embodiments, a larger quantity of magnets made of a material having weaker magnetic properties, for example, ceramic magnets may be used to adequately secure the badge 102 and the badge holder 100 to one another.

When the badge 102 is disposed in the badge holder 100, the spacing and polarity of the magnets 408 and 508 described above align such badge 102 and the badge holder 100 so that the electrical contacts 418 and 518 are electrically coupled to one another. The processor 300 can use the input/output module 306 to read data from the secure memory 414 and actuate the LEDs 406.

In some embodiments, the magnets 408 and 508 may be electrically coupled, for example, with a conductor to the circuits in the badge holder 100 and badge 102, respectively. In such embodiments, the magnets 408 and 508 supply the electrical contacts 414 and 518, respectively.

It should be apparent that ways other than magnets 408 and 508 may be used to couple the badge holder 100 and the badge 102, respectively. For example, the badge holder 100 may include one or more slots and the badge 102 may include one or more corresponding protrusions that fit into such slots to secure the badge 102 and the badge holder 100 in a “keyed slot” manner. It should be apparent the badge holder 100 may have such protrusions and the badge 102 the slots. Further such slots and protrusions may be disposed on any face of badge 102 or badge holder 100 that contacts a corresponding face of the badge holder 100 or badge 102, respectively.

In some embodiments, the badge holder 100 and badge 102 may be affixed to one another using an adhesive or by being co-molded to one another. In other embodiments, miniature connectors with detents may be used instead of the magnets 408 and 508 and the electrical connectors 418 and 518 to electrically and physically couple the badge holder 100 and badge 102. Any other type of fastener apparent to those of skill in the art may be used to couple the badge holder 100 and badge 102. The electrical contacts 418 may also be used to initially write data into the secure memory 414 when the badge 102 is manufactured or initially authorized.

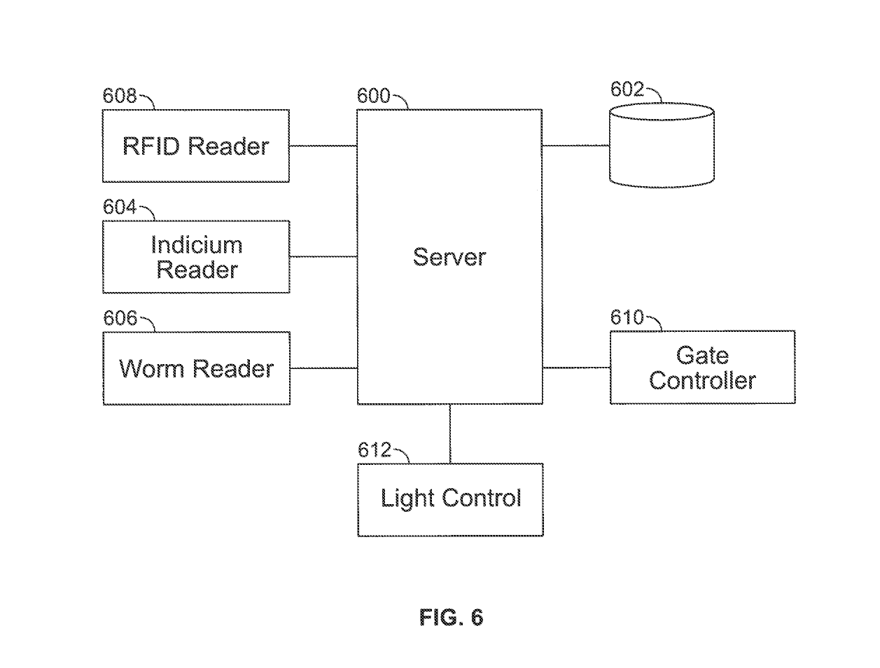

FIG. 6 is a block diagram of a system to validate the authenticity of a badge 102 and to actuate the badge 102. The system comprises a server 600 and a database 602 associated therewith. The database 602 includes an entry for each badge 102 available for a particular event and specifies whether such badge 102 has been sold, whether the badge 102 has been presented for entry, identifying information of the badge 102, and information about the purchaser or attendee associated with the badge 102.

When a badge 102 is presented for entry to an event, one or more of an indicium reader 604, a secure memory reader 606, and an RFID reader 608 retrieve the data encoded in the one or more unique indicia 412, the secure memory 414 and the RFID circuit 416, respectively. Such readers 604, 606, and 608 provide the data retrieved thereby to the server 600, which compares such data with the entry in the database 602 associated with the badge 102 to validate the authenticity of the badge 102. Typically, the readers 604, 606, and 608 are located at an entry gate where the badge 102 is presented for admittance. The server 600 and the database 602 are typically located in a central location either at the same venue as the readers 604, 606, and 608, or at location that is remote from such venue. It should be apparent that any communication means including Ethernet, 802.11, fiber optic, and the like may be used for communications between the readers 604, 606, and 608 and the server 600.

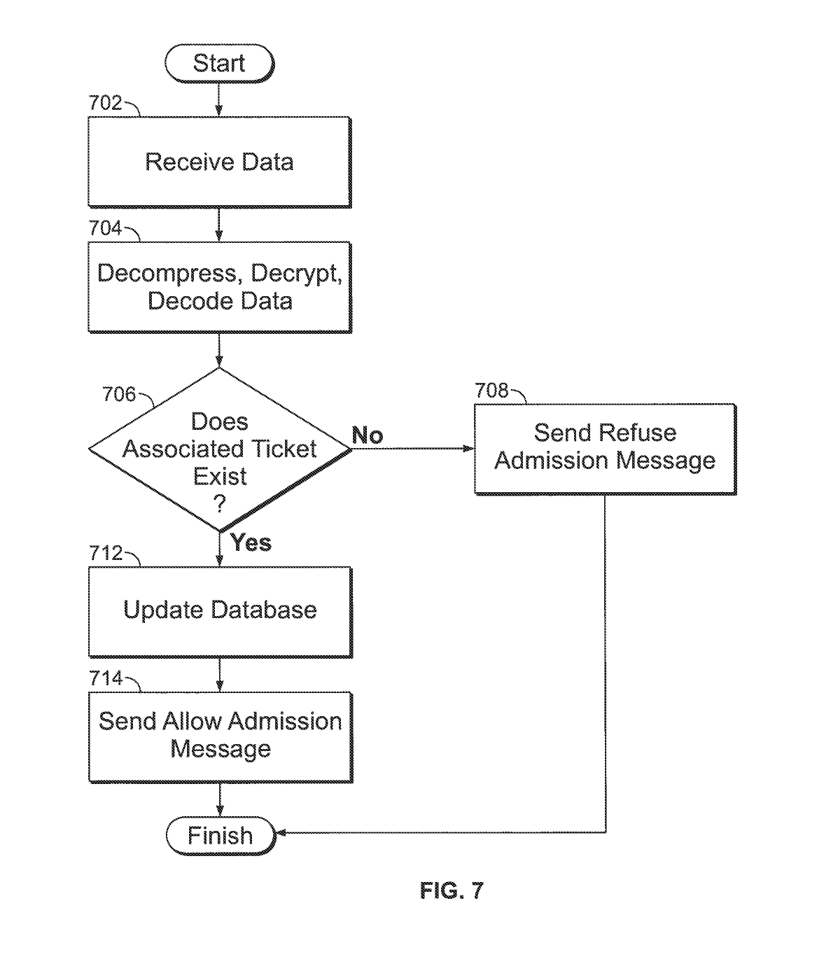

FIG. 7 shows a flowchart of processing undertaken by the server 600 to validate the authenticity of the badge 102. A block 702 receives data from one or more of the readers 604, 606, and 608. In some embodiments, the block 702 may receive additional data that identifies the attendee who presented the badge 102 for entry. Such additional identifying data may include credit card information, driver's license information, and the like associated with the attendee. Such additional identifying data may be sent to the block 702 by an electronic reader of such data (for example, a credit card reader) or from a computer terminal into which such information was entered.

In some embodiments, the data transmitted by the reader 604, 606, or 608 may be encrypted for security, encoded for error correction, and/or compressed to reduce transmission time. A block 704 decompresses, decrypts, and/or decodes, the data received by the block 702.

A block 706 queries the database 602 to identify an issued badge 102 associated with the data sent by the readers 604, 606, and/or 608 and if such badge is not identified or has been reported stolen or missing, a block 708 sends a message to a gate control system 610 that indicates that admittance to the event should be refused to the attendee who presented the badge 102. The gate control system 610 may be coupled to a turnstile or other entry device and the message sent by the block 708 locks the turnstile. The gate control system 610 may display a message or illuminate an indicator (for example, a red light) that indicates that admittance is denied. Typically, the gate control system 610 is located near the readers 604, 606, and/or 608. The gate control system 610 may also actuate an alarm to indicate that the authenticity of the badge 102 presented for entry cannot be validated. The gate control system 610 and/or server 600 may notify security personnel at the venue that the badge 102 has been presented and the authenticity thereof cannot be validated.

Some venues may have an attendant to whom the server 600 may send a message that indicates whether an attendee who has presented the badge 102 should be granted or denied admittance.

in some cases admission to an event may require authentication of only one of the unique indicia 412, secure memory 414, and RFID 416 associated with the badge 102. In other cases, authentication of a plurality or all of the one or more unique indicia 412, secure memory 414, and RFID 416 associated with the badge 102 may be required to gain admittance to an event.

Referring once again to FIG. 2A, during the event, the attendee associated with the badge 102 and badge holder 100 may be directed to press the mode select button 200. Doing so may cause the control unit 204 to activate a first mode in which the LEDs 406 are actuated at a first predetermined brightness. Pressing the mode select button 200 again may cause the control unit 204 to activate a second mode in which the LEDs 406 are actuated at a second predetermined brightness. Pressing the mode select button 200 still again may cause the control unit 204 to activate a third mode in which the LEDs 406 pulse at a predetermined rate. A fourth mode of operation by the control unit 204 may be activated by pressing the mode select button 200 in which the control unit 204 monitors signals from the sensor 202 associated with light and/or sound emitted by sources at the venue. In response to such signals, the control unit 204 actuates the LEDs 406 to emit light in synchrony with such emissions of light and/or sound. It should be apparent that the control unit 204 may be programmed with a variety of such modes. Further, it should be apparent that the order in which such modes are activated may also be programmed into the control unit 204.

Referring once again to FIG. 6, a light control 612 may be coupled to the server 600 that allows the server to remotely control the operation of the LEDs 406 disposed on the badge 102 or alternately the badge holder 100. In particular, the server 612 may cause a light source at a venue to emit particular patterns, intensities, and/or wavelengths of light that are detected by the sensor 202 of the badge holder 100. The control unit 204 in the badge holder 100 may receive and respond to signals from the sensor 202 associated with such emissions as described above.

For example, the server 600 may cause the light controller 612 to flash a light source at the venue in a predetermined pattern and/or at a particular wavelength or combination of wavelengths. The duration of the flashes and/or the wavelengths of emissions by the light source may or may not be perceptible to attendees present at the venue but may be detected by the sensor 202. Upon detection of such emissions, the control unit 204 in the badge holder 100 may generate a signal to operate the LEDs 406. Depending on the pattern and/or wavelengths generated by the light source, the control unit 204 may actuate the LEDs 406 to illuminate a particular color or to flash in a particular sequence or for a particular duration.

In some embodiments, the server 600 may use information in the database 602 regarding a seat or location in a venue with which each badge holder 100 and badge 102 inserted therein are associated. The server 600 may signal the control unit 204 of the badge holder 100 at a particular seat to cause the LEDs 406 associated therewith to emit a particular pattern of light. If the server 600 signals the control units 204 of a group of badge holders 100 and corresponding LEDs 406 in this fashion, each illuminated badge 102 inserted in such badge holder 100 may form an element of an image or pattern formed by the group of badges 102.

In some embodiments, the server 600 may flash the LEDs 406 associated with a badge 102 of a particular attendee, for example, to identify such attendee as a winner of a contest or to deliver a message, for example, an emergency message, to such attendee.

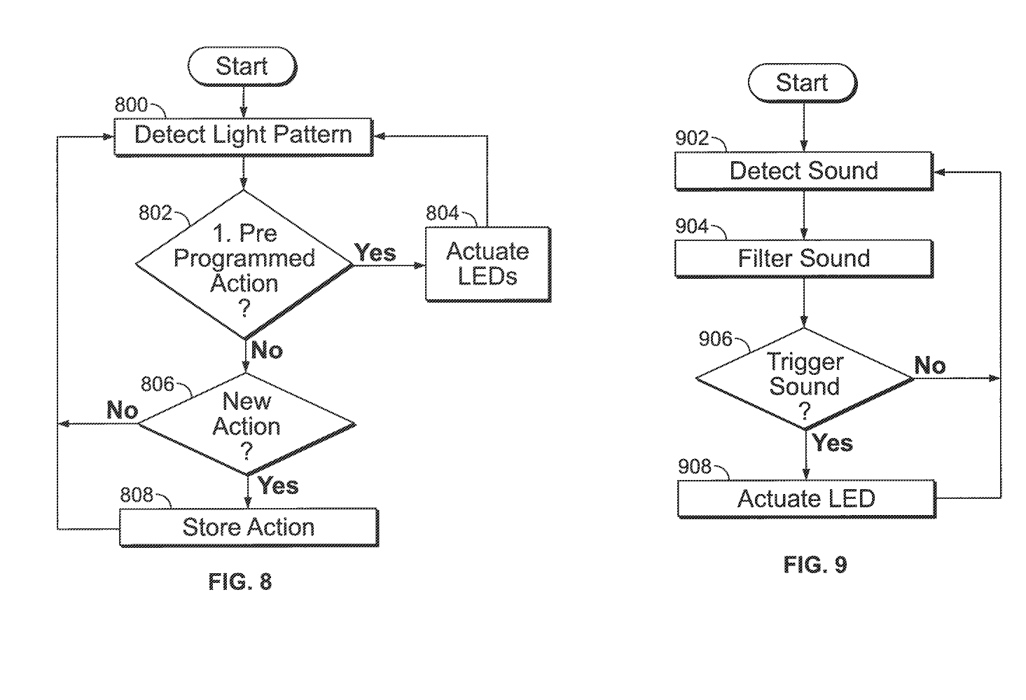

FIG. 8 is a flowchart of the processing undertaken by a control unit 204 of a badge holder 100 in response to light emissions in the venue. A block 800 detects a particular pattern of light emissions. Such pattern may include a combination of pulses having predetermined wavelengths of light that are emitted for a predetermined duration. In some embodiments, a first pulse having a first wavelength of light and lasting a first duration signals the beginning of a pattern of pulses. Upon detecting such a pulse, the block 800 monitors the pulses of light until the block 800 detects a second pulse having a second predetermined wavelength of light lasting a second predetermined duration. The wavelengths and duration of each pulse received by the block 800 between the first and second pulses comprise a combination of pulses that represents a command to the control unit 204.

A block 802 determines if the command is associated with a pre-programmed action and, if so, execution proceeds to a block 804. Otherwise execution proceeds to a block 806. The block 804 actuates the LEDs 406 in accordance with the action associated with the preprogrammed action. Examples of such preprogrammed actions include actuating the LEDs 406 to emit light of a particular wavelength until another command is received by the block 802, actuating the LEDs 406 to emit light of particular wavelength for a specific period of time, and actuating the LEDs 406 in a predetermined pattern of pulses wherein each pulse has a particular wavelength and last a certain amount of time. Other preprogrammed actions may cause the control unit 204 to monitor sound in the venue and actuate the LEDs 406 in accordance with such sound as described further below. Other preprogrammed actions apparent to those of skill may be used.

The block 806 determines if the command is associated with a request to record a new action and, if so, stores the new action in a memory 302 of the control unit 204. In one embodiment, the command to record the new action is followed by a combination of light pulses that comprises the command that may be used to trigger the new action. After the block 806 receives such combination, the block 806 receives a pattern in Which the LEDs 406 should be actuated when a command is received to undertake the new action. Processing proceeds to the block 800 to await another light pattern after completion of the blocks 804 and 808 or if the block 806 determines that the data representing the pattern is not associated with a request to record a new action.

FIG. 9 is a flowchart of processing undertaken by the control unit 204 to actuate the LEDs 406 in synchrony with received sound. A block 902 receives a sound signal from the sensor 202. In some embodiments, the sensor 202 may include an amplifier to amplify the received sound. In other embodiments, the block 902 may direct the received sound signal through an amplifier separate from the sensor 202. A block 904 filters the sound to determine if one or more particular frequencies at one or more corresponding particular amplitudes were received at the block 902. In some embodiments, the block 902 may use the DSP 308 to analyze the frequencies and amplitudes thereof that comprise the received sound signal. In other embodiments, the block 902 may use a bandpass filter to determine if sound signal received by the block 902 comprises a particular frequency and the amplitude thereof.

A block 906 determines if the frequency or frequencies identified by the block 902 and amplitude thereof are associated with a particular action to be undertaken by the control unit and, if so, control proceeds to a block 908. Otherwise processing proceeds to the block 902 until another sound is detected. The block 908 actuates the LEDs 406 in accordance with the particular action associated with the received frequencies and then proceeds to the block 902 to wait for an additional sound signal.

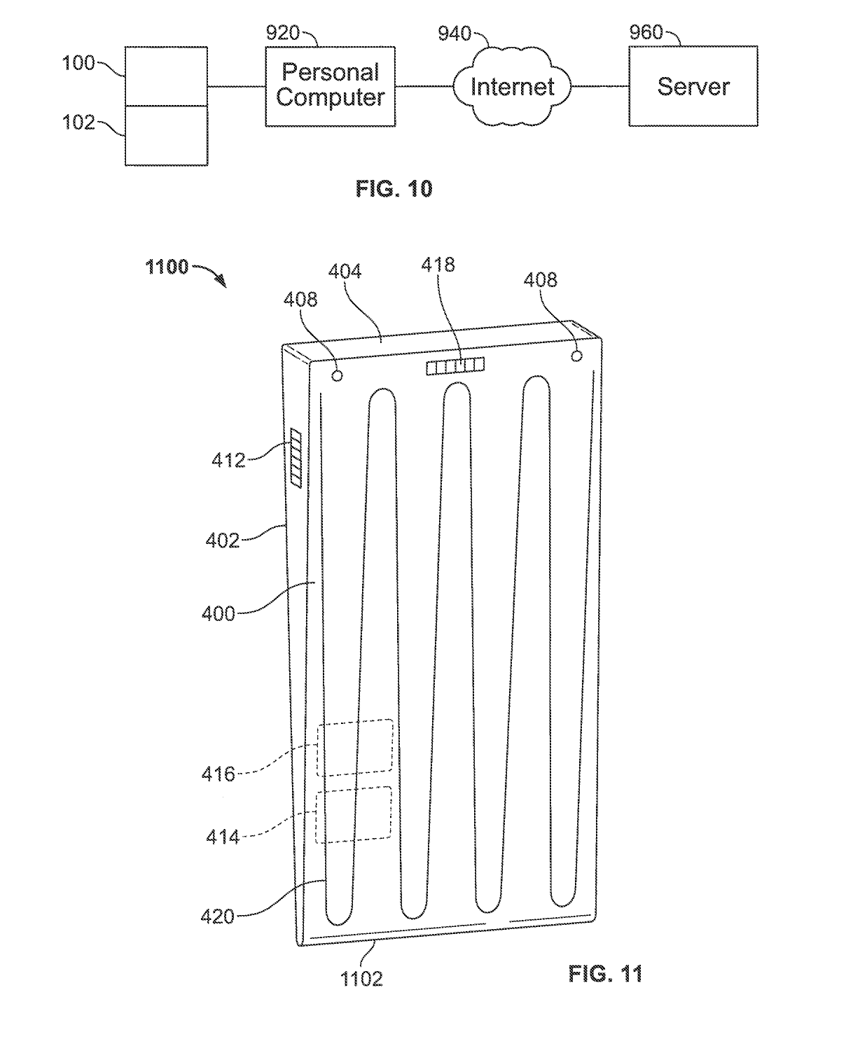

The badge holder 100 and the badge 102 may be used after the event associated therewith to access additional content related to such event. FIG. 10 is a block diagram in which the badge holder 100 with the badge 102 inserted therein is coupled to a personal computer 920, for example, by connecting one end of a USE cable into the communication port 122 and the other end into the personal computer 920. In such cases, the processor 300 uses the USE control module 314 to transmit and receive data to and from the personal computer 920, respectively. Alternately, the badge holder 100 may communicate with the personal computer 920 using, for example, Bluetooth or 802.11. In such cases, the processor 300 uses the wireless module 310 to transmit and receive data to and from the personal computer 920, respectively.

The personal computer 920 may use the Internet 940 to communicate with a server 960. In some embodiments, the personal computer 920 has software installed thereon that detects when the badge holder 100 is connected to the personal computer 920. Upon such detection, the software initiates communication with the server 960. In some cases, the software on the personal computer 920 may be a web browser that connects via the Internet 940 to a web server 960. In other cases, the software on the personal computer 920 may be a stand-alone application program that communicates with software installed on the server 960.

The software operating on the server 960 may request that the software on the personal computer 920 obtain and transmit the security data stored in the secure memory 414 of the badge 102. In response, the software on the personal computer 960 communicates with the processor 300 in the badge to obtain such data and transmits such data to the software operating on server 960. Further, the software operating on the server 960 may request that the software on the personal computer 920 obtain and transmit thereto information associated with the user (such as a login and/or password, credit card information, and the like). The software operating on the personal computer 920 obtains such information, for example, by presenting a dialog box or displaying a web form, and transmits information entered therein by the user to the software operating on the server 960.

The software on the server 960 analyzes the information from the badge 102 and the user to validate the authenticity of the badge 102. If the badge 102 is authentic, the software on the server 960 allows the user to use the software on the personal computer to access content on the server 960. Such content may include recordings and or transcripts of the event, user forum or fan club associated with the event, opportunities to purchase or receive memorabilia associated with the event, and the like. For example, if the event is a musical event, the user may access a play list of the music performed during the event, download music played at the event, view videos of the event, and/or purchase or receive posters of the performer at the event. The user may also be provided opportunities to purchase a badge for a future event.

The software operating on the server 960 may direct the software on the personal computer 920 to download an upgrade to software stored in the memory 302 of the badge holder 100 that controls the operation thereof Similarly, the software operating on the server 960 may direct the software on the personal computer 920 to download and store in the memory 302 additional actions that are responsive to light or sound stimulus at an event.

The software operating on the server 960 may authorize the badge 102 inserted in the badge holder 100 so that such badge 102 may be used for a future event, for example, by inserting an entry in the database 602 that indicates that the badge 102 can be used to gain admittance to the future event.

In one embodiment, the user obtains a badge holder 100 and uses such badge holder 100 with a plurality of separate badges 102 to attend events corresponding to each badge 102. In other embodiments, the user may obtain a badge holder 100 and a badge 102 and use such badge 102 to attend multiple events by having such badge 102 validated by the software on the server 960 as described above.

Referring to FIG. 11, in one embodiment, a badge 1102 similar to the badge 102, has a bottom surface that is narrower than the top surface 404 thereof. Disposed on the front surface 400 of the badge 1102 are magnets 408 that may he used to removably attach the badge 102 to a badge holder described below. Electrical contacts 418 are also disposed on the front surface 418 of the badge 102. The badge 1102 may include one or more of unique indicia 412, a secure 414, an RFID circuit 416 and light guides 420, which are functionally identical to those described above. The badge 1102 may also be printed with a QR code or other information as described above.

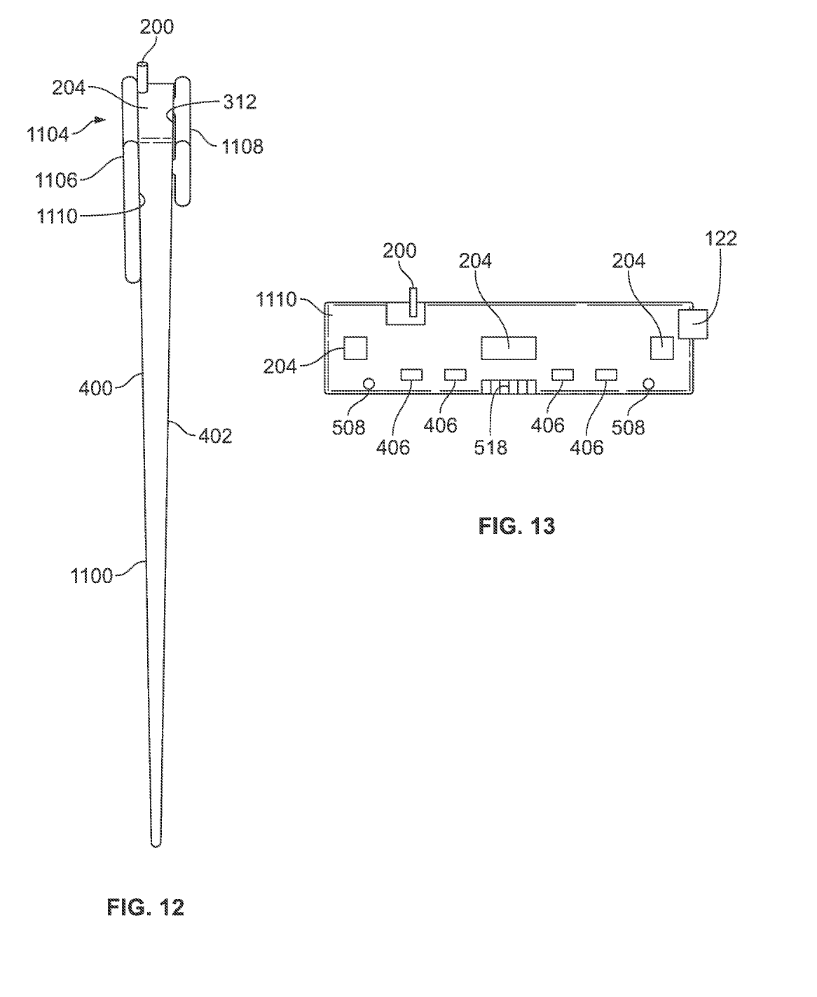

Referring to FIG. 12, the badge 1102 is disposed in a badge holder 1104. The badge holder 1.104 includes a front portion 1106 and the rear portion 1108. A control unit 204 is disposed between such front portion 106 and rear portion 108. The rear portion 106 may comprise the power source 312, such as a Lithium Polymer rechargeable battery. The front portion 108 has an inner surface 1110 onto which the electrical control unit 204 is disposed. Further, in some embodiments, the secure 414 and/or RFID circuit 416 may be disposed on front or rear portion, 1104 or 1108, respectively of the badge holder 1104.

Referring to FIG. 13, the inner surface 1110 of the front portion 106 of the badge holder 1104 includes control circuitry 204, as described above with respect to FIG. 3. The inner surface 1110 also include magnets 508 and an electrical connection 518 that couple with the magnets 408 and the electrical connection 518, respectively, on the badge 1100. The inner surface 1110 also has LEDs 406 disposed thereon. In one embodiment, the LEDs 406 are right-angle LEDs that project light onto the front surface 400 of the badge 1100 when such badge 1100 is disposed in the badge holder 1104. In another embodiment, the LEDs 406 are right-angle LEDs that project light through the top surface 404 and into the body of the badge 1100. It should be apparent that a combination of LEDs 406 that project onto the front surface 400 and the top surface 404 of the badge 1100 may be used.

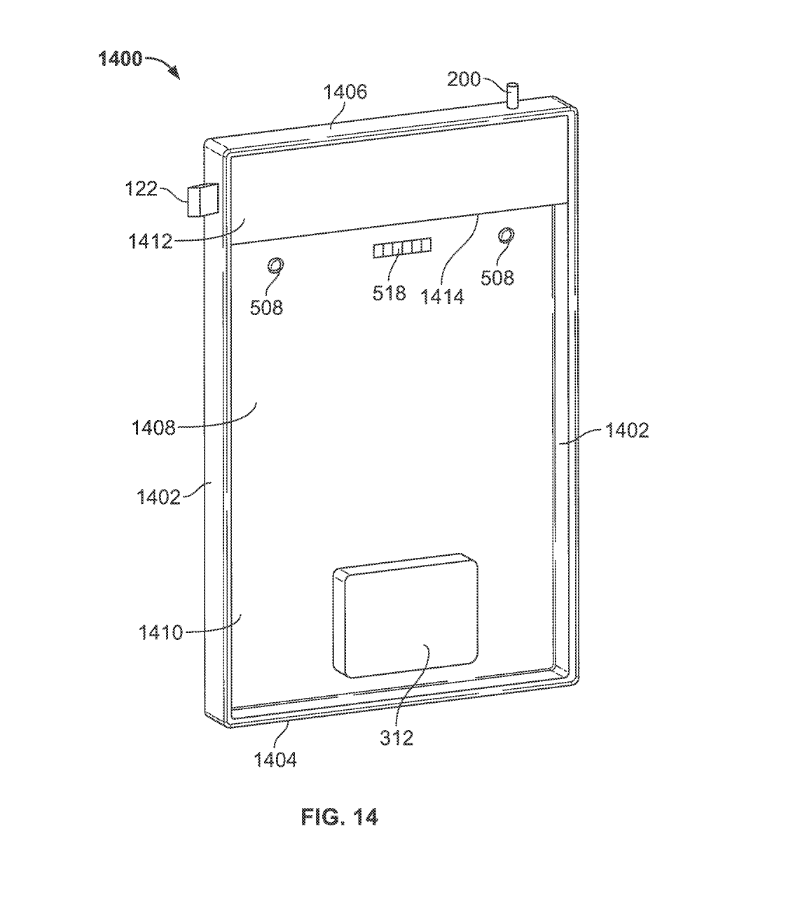

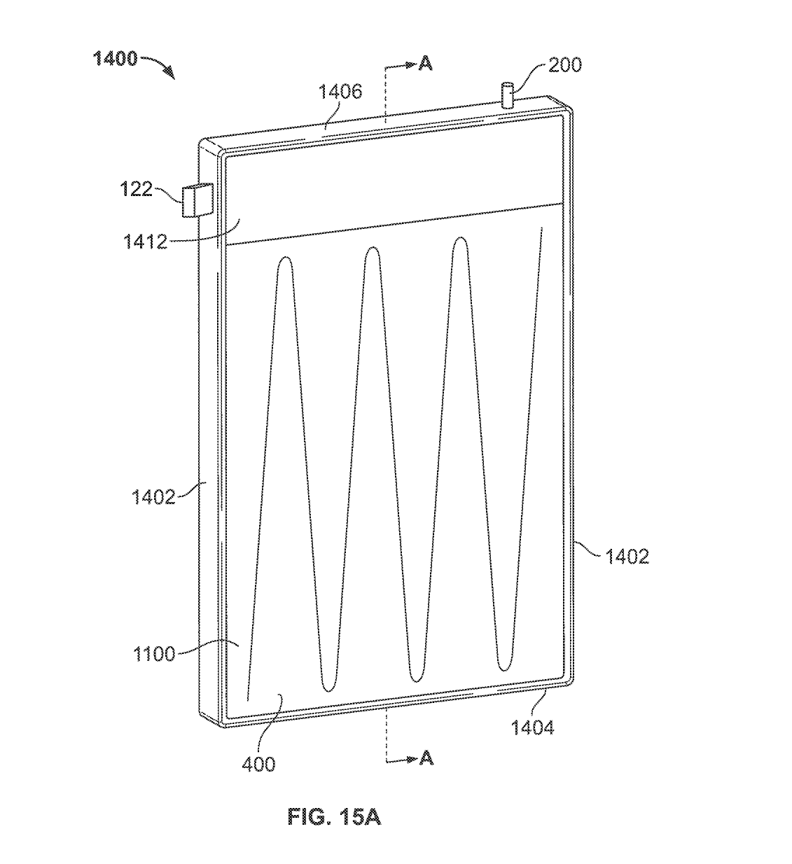

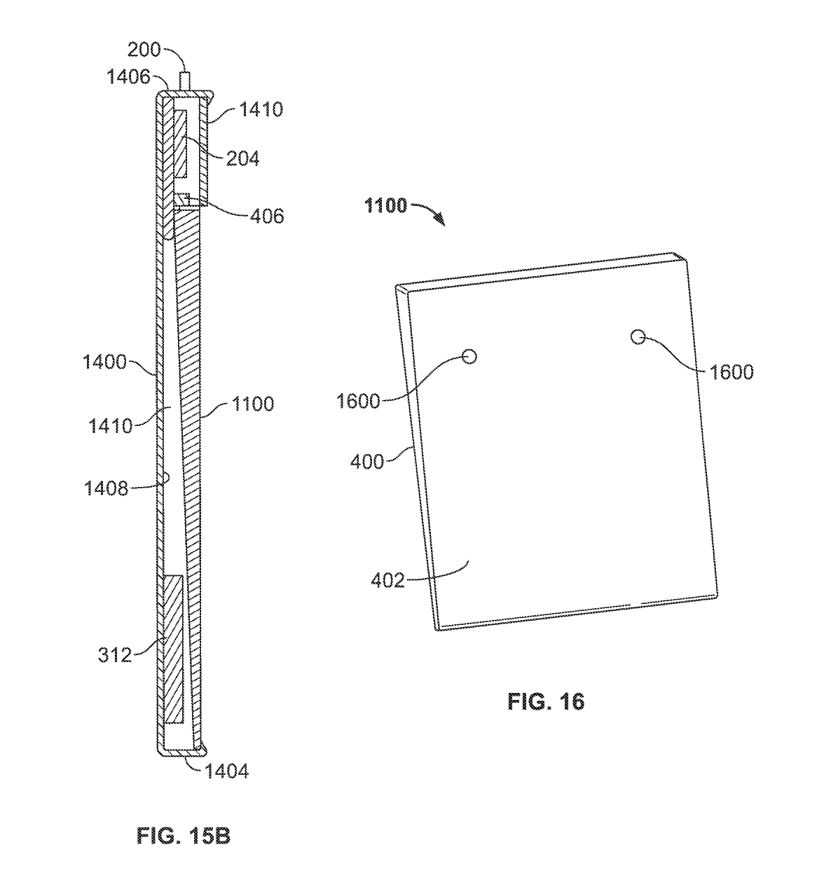

Referring to FIG. 14 and FIG. 15A another embodiment of a badge holder 1400 includes sidewalls 1402, a bottom wall 1404, a top wall 1406, and rear surface 1408 that form a cavity 1410 into which the badge 1100 may be disposed. The rear surface 1408 comprises the magnets 508 and the electrical connection 518 which couple to the corresponding magnets 408 and electrical connection 418 on the badge 1100. The badge holder 1400 also includes a front portion 1412 similar to the front portion 1106 described above. Disposed on an interior surface 1414 of the front portion 1412 are the LEDs 406, the control circuitry 204, and, optionally, the secure 414 and/or the RFID circuit 416 as described above. It should be apparent that if the badge 1100 is used with the badge holder 1400, the magnets 408 and the electrical connection 418 are disposed on the rear surface 402 of the badge 1100 instead of the front surface 400 thereof.

In some embodiments, the magnets 508 and electrical connection 518 are disposed on the interior surface 1414 of the front portion 1412 of the badge holder 1400. In such embodiments, the badge 1100 may be disposed in badge holder 1400, for example, by inserting the top portion of the badge 1100 under the front portion 1412 such that magnets 408 and 508 make contact.

Referring to FIG. 15B, in one embodiment the badge 1100 is disposed in the cavity 1410.

Referring to FIG. 16, one embodiment of the badge 1100 includes one or more pockets 1600 disposed on the rear surface 402 thereof The LEDs 406 may be disposed in such pockets 1600 such that the light emitted thereby projects into the body of the badge 1100, through the front of the badge 1100, towards the rear surface 402 of the badge 1100 or a combination thereof. In some embodiments, the pockets 1600 may be disposed on the front surface 400 of the badge 1100.

In one embodiment, the LEDs 406 are secured in the pocket 1600 of the badge 1100 and are electrically coupled to the control unit 204 through the electrical contacts 418. In another embodiment, the LEDs 406 are secured to the badge holder 100, 1104, or 1400, positioned so that the LEDs 406 protrude into the pockets 1600, and are coupled to the control unit 204 using conductors in the badge holder 100, 1104, or 1400. In a still further embodiment, some LED's 406 are secured in some pockets 1600 and other LEDs 406 are secured to other pockets 1600.

Although the badge holder 100, 1104, 1400 and the badge 102, 1100 are described herein as separate units, it should be apparent that the badge holder 100, 1104, 1400 and the badge 102. 1100 may be combined into a single unit.

### INDUSTRIAL APPLICABILITY

The badge and badge holder described herein may he utilized to provide entry to an event, respond to the environment during the event, and provide access to content after the event. Further, numerous modifications to the present invention to enhance the efficacy of the badge and badge holder will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications that come within the scope of the appended claims are reserved.

We claim:

1. A badge holder, the badge holder comprises:
an illumination device;
a badge;
a memory; and
a controller, wherein the controller receives environmental conditions sensed by a sensor and, in response, actuates the illumination device.

2. The badge holder of claim 1, wherein the badge is associated with a security identifier stored in one of a barcode, a serial number integrated circuit, an encrypted memory, and a two-dimensional barcode.

3. The badge holder of claim 2, wherein the controller provides the security identifier to a security computer and the security computer validates authenticity of the badge.

4. The badge holder of claim 1, wherein the illumination device illuminates a surface of the badge.

5. The badge holder of claim 1, wherein the environmental conditions sensed by the sensor includes a change audio or illumination in the environment.

6. The badge holder of claim 5, wherein the controller operates the illumination device in synchrony with a change in sound or illumination in the environment.

7. The badge holder of claim 6, wherein the controller operates the illumination device in accordance with an action stored in the memory.

8. The badge holder of claim 7, wherein the action is transmitted to the controller.

9. The badge holder of claim 8, wherein the action is transmitted to the controller by changing the illumination in the environment.

10. The badge holder of claim 1, wherein the memory includes data stored therein and the controller is adapted to transmit such data to a server.

11. The badge holder of claim 10, wherein the controller is adapted to receive additional data from the server and store the additional data in the memory.

12. The badge holder of claim 10, wherein the controller is adapted to communicate with a computer.

13. The badge holder of claim 10, wherein computer receives content from the server in response to transmission of data to the server by the controller.

14. The badge holder of claim 1, wherein the badge is removeably secured to the badge holder.

15. The badge holder of claim 1, wherein the badge includes light guides.

16. The badge holder of claim 1, wherein the light from the illumination device is projected outwardly through a front surface of the badge.

17. The badge holder of claim 16, wherein the light from the illumination device is reflected from a rear surface of the badge and directed toward the front surface of the badge.
